(19) United States
(12) Patent Application Publication
(10) Pub. No.: US 2014/0055368 A1
(43) Pub. Date: Feb. 27, 2014

(54) Method and Apparatus by Using Touch Screen to Implement Functions of Touch Screen and Keypad

(71) Applicants: Ming-Hsein Yu, Taipei (TW); Tzong-Jey Chen, Taoyuan (TW); Fan Hung Yang, New Taipei City (TW)

(72) Inventors: Ming-Hsein Yu, Taipei (TW); Tzong-Jey Chen, Taoyuan (TW); Fan Hung Yang, New Taipei City (TW)

(21) Appl. No.: 13/591,261

(22) Filed: Aug. 22, 2012

(51) Int. Cl. G06F 3/041

(52) U.S. Cl. 345/173

(57) ABSTRACT

The present invention discloses a method and apparatus by using touch screen to implement functions of touch screen and keypad, to increase one extra function, keypad, in a touch display. The purpose can be achieved by adding one data processor and modifying firmware of video processor. The data processor converts touch data into touch data and key data. The two data are sent out through two data interfaces. The two data flows can be thought as data from two independent devices. Besides, the two data flows can be directed to either one single system or two systems.

### BACKGROUND OF THE INVENTION

1. Field of the Invention

The present invention relates to a method and an apparatus to construct both functions of touch screen and key pad on a touch display. And more particularly this is a method and an apparatus by adding a Data Processor into data path to translate a touch display becoming two components, touch display and key pad.

2. Description of the Related Art

A general touch display is composed of a Display and a Touch Screen. FIG. 1 (prior art) shows the connection among Display, Touch Screen and System. Referring to FIG. 1, Display 102 and Touch Screen 104 are two independent devices. System 118 can be any kind of Central Processing Unit (CPU) or Personal Computer (PC). The relation between touch data, coming from Touch Screen 104, and control objects, like buttons, shown on Display 102 is implemented in application software running on System 118. Video signal to Display 102 is provided by Graphic Chip 114. Video Processor 110 processes the video signal and sends it to Display Panel 106. Then, Display Panel 108 can show the video. Touch Panel 108 in Touch Screen 104 senses touch action and produces touch signal. Touch signal is converted to digital touch data by Touch Controller 112. Touch data is then sent out through Universal Serial Bus (USB) or Universal Asynchronous Receiver/Transmitter (UART/RS232) 116. Application software running on System 118 will process touch data and video data to provide touch function.

One application of Touch Display is shown in FIG. 2 (prior art). A Point of Sales (POS) system 200 is mainly composed of Touch Screen Monitor 202, Programmable Keyboard 204, Pole Display 206, Receipt Printer 208, Magnetic Stripe Reader 210, Barcode Printer 212, Barcode Scanner 214, Data Collection 216 and Cash Drawer 218, etc. Among these peripherals, Programmable Keyboard is of larger size and space consuming.

It is desirable to build up the keyboard function by using touch display to get a system being more efficient, space saving, and cost saving.

### OBJECTS OF THE INVENTION

It is therefore an object of the invention to provide a method to implement functions of touch display and keypad by using touch display only. By adding a data processor in the transmission path of touch data, Touch Display can have keypad function in addition to original touch function. The implementation does not need application software to handle it. From system side, there still are two devices although it is one actually.

It is another object of the invention to provide an apparatus, built up by touch display only, with touch function and keypad function to save cost and space.

### DISCLOSURE OF THE INVENTION

A first aspect of the present invention teaches a method to implement both touch function and keypad function in a touch display. To add a data processor in transmission path of touch data to convert touch display into two virtual devices, touch display and keypad. This data processor receives touch data from touch controller and processes these data to get two set of data, touch coordinate and key code. Video processor accepts video signal from System and shows it on video window. On the other hand, video processor generates keypad image which is shown on key window. Under the cooperation of data processor and video processor, one virtual keypad is implemented on touch display.

A second aspect of the present invention teaches an apparatus built up by touch display only but having function of touch display and keypad. By adding a data processor on the path of touch data to convert touch display into two devices, touch display and keypad. It includes one or two systems with CPU and graphic function and one touch display composed of display screen and touch screen. Touch screen can be capacitive type, resistive type, or any other types. Display screen has one video processor to display video signal from system and keypad image onto video window and key window, respectively. Touch Screen has one touch processor which is composed of touch controller and data processor. Touch controller converts touch signal into digital touch data which represents position data or touch coordinate. Data processor interprets touch data and divides the data into touch coordinate and key code. Touch coordinate and key code are sent to system via two different paths. The transmission interface can be USB or UART/RS232.

### BRIEF DESCRIPTION OF THE DRAWINGS

FIG. 1 (prior art) shows the connection between display, touch screen and system.

FIG. 2 (prior art) shows one application of touch display.

FIG. 3 shows data flow of video signal and touch data, where touch data is split into touch coordinate and key code, according to the present invention.

FIG. 3(A) shows flow of touch data.

FIG. 3(B) shows flow of video signal.

FIG. 4 shows block diagram and data between touch display and system according to the present invention.

FIG. 4(A) shows the case with one single system.

FIG. 4(A) shows the case with two separate systems.

FIG. 5 shows one example of video on Touch Display, including video window and key window.

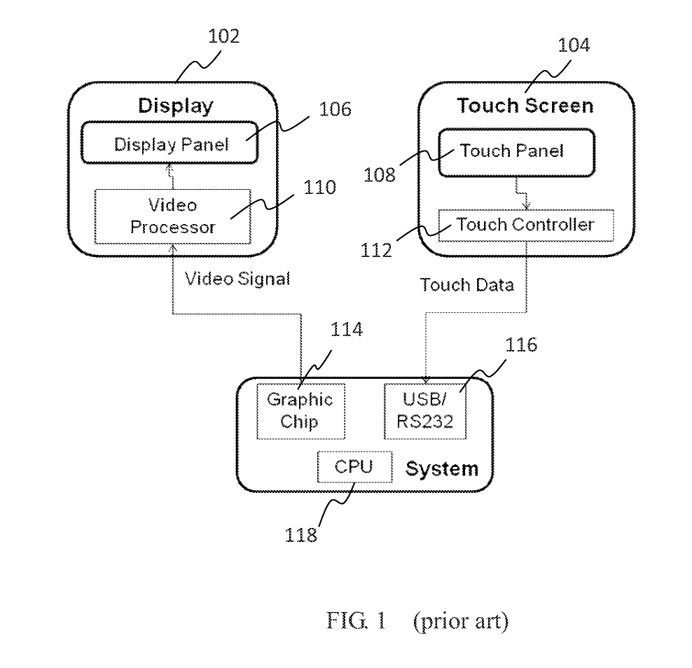

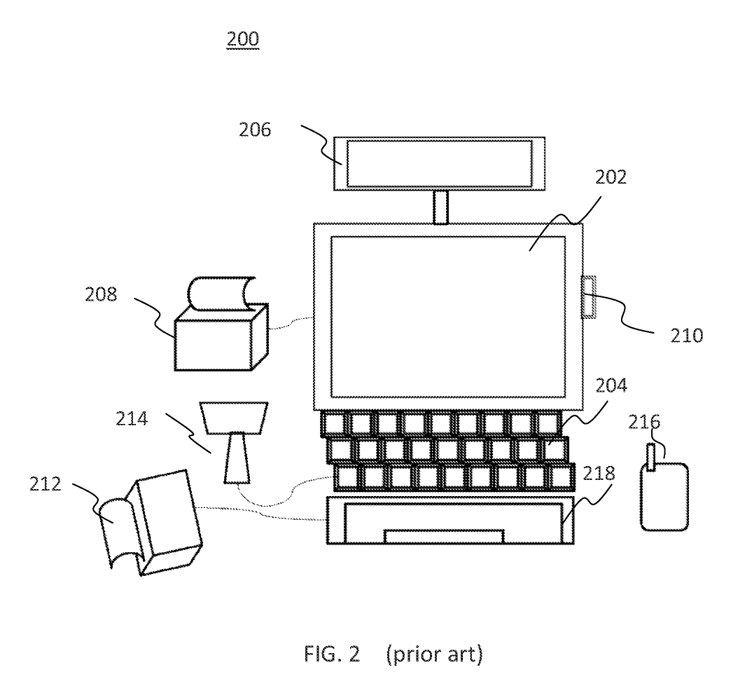

### DESCRIPTION OF THE PREFERRED EMBODIMENTS

The foregoing and other advantages of the invention will be more fully understood with reference to the description of the best embodiment and the drawing as the following description.

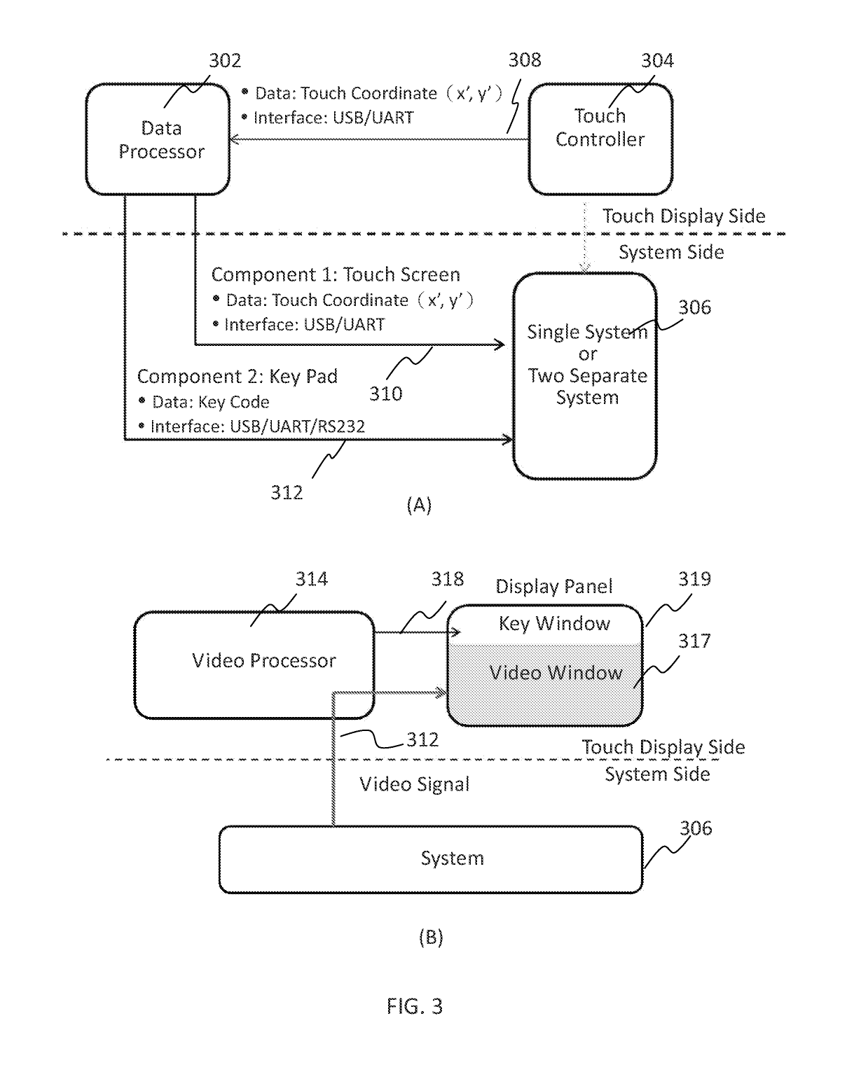

Please refer to FIG. 3. FIG. 3 shows signal flow of the system according to the present invention. Touch data flow is shown in FIG. 3(A). Touch Controller 304 senses touch signal from touch panel and converts the signal into touch coordinate, (x, y). Then, touch coordinate is sent to Data Processor 302 through Universal Serial Bus (USB) or Universal Asynchronous Receiver/Transmitter (UART/RS232) 308. Data Processor 302 classifies touch data into touch coordinate and key code. The two data sets are sent out through two individual USB or UART/RS232. System that receives these data can be one single system or two separate systems 306. FIG. 3(B) shows video signal flow. System sends out video signal through Video Interface 312 to Video Processor 314. The video interface can be Video Graphic Array (VGA) or High-Definition Multimedia Interface (HDMI) or other ones. The corresponding display of video signal is put on Video Window 317 by Video Processor 314. Moreover, Video Processor 314 also generates a keypad image and maps it to Key Window 319. The mixed signal with two windows image is sent to Display Panel. Video Window 317 and Key Window 319 will be displayed on Display Panel simultaneously.

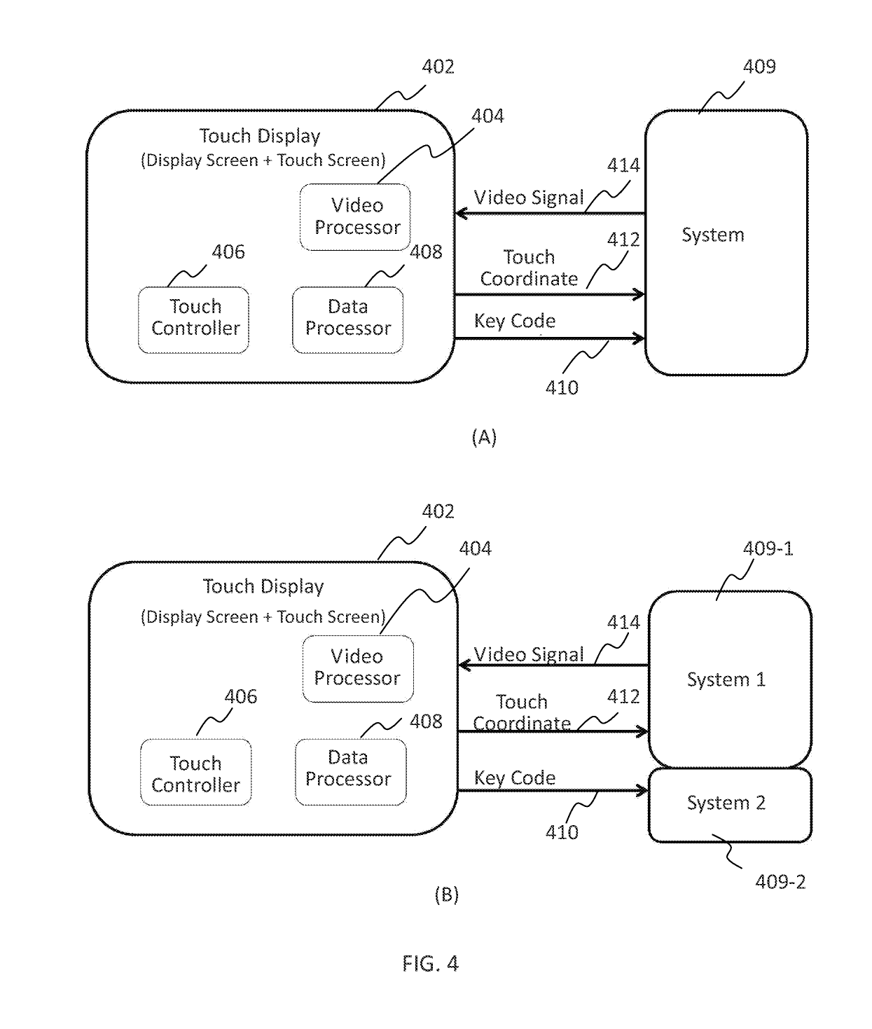

FIG. 4 shows block diagram and data between touch display and system according to the present invention. FIG. 4(A) shows the case of one single system. Touch Display 402 is a combination of Display Screen and Touch Screen. Video Processor 404 in Display Screen maps video signal from System 410 through Video Interface 414 to video window. Touch Screen contains Touch Controller 406 and Data Processor 408. Touch Controller 406 senses touch signal of Touch Screen and converts it into digital touch data. Touch Processor 408 splits touch data into touch coordinate and key code and sends the two sets of data to System 409 through two USB or UART/RS232 ports 410, 412. FIG. 4(B) shows the case with two separate systems 409-1, 409-2; one receives touch coordinate via USB or UART/RS232 port 412 while the other accepts key code via USB or UART/RS232 port 402.

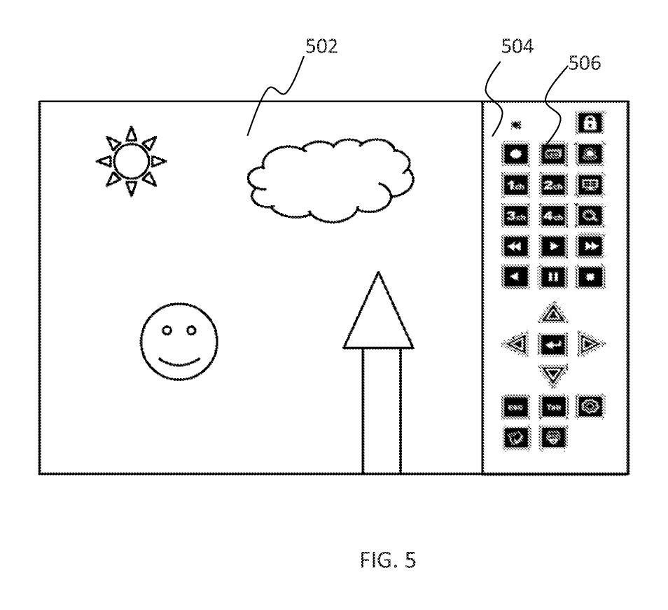

Please refer to FIG. 5. FIG. 5 shows one example of video on Touch Display, including video window and key window. One part of display is Video Window 502 and the other part is Key Window 504 which includes some keys 506. Therefore, physical keypad is not necessary any more. This will be more efficient, space saving and cost saving.

The embodiments presented above are for purposes of a clearer demonstration and plays only one example of application. The above specified example is not to be taken to limit the scope of the appended claims. On the contrary, the purpose is to cover various changes and equivalent arrangements in the claims of the present invention.

Although specific embodiments of the invention have been disclosed, it will be understood by those having skill in the art that minor changes can be made to the form and details of the specific embodiments disclosed herein, without departing from the scope of the invention. The embodiments presented above are for purposes of example only and are not to be taken to limit the scope of the appended claims.

What is claimed is:

1. A method to build up touch function and keypad function on one touch display. By adding one data processor on transmission path of touch data, touch display becomes two virtual components, touch display and keypad, comprising:
Data processor to split touch data from touch controller into touch coordinate and key code;
Video processor maps video signal from main system to video window and generates keypad image on key window;
Under the cooperation of data processor and video processor, one virtual keypad is implemented on touch display.

2. A method or apparatus as recited in claim 1, wherein said main system has one single system.

3. A method or apparatus as recited in claim 1, wherein said main system has two separate systems.

4. An apparatus composed of touch display, has functions of both touch display and keypad by inserting one data processor into touch data path, comprising:
A main system, composed of central processing unit (CPU) and graphic chip;
A touch display, composed of display screen and touch screen, the display screen has video processor to show video signal from system and keypad image on video window and key window, respectively, the touch screen can be of any type, e.g., capacitive type, resistive type, SAW type, the touch screen has a touch processor with the functions of touch controller and data processor, touch controller converts touch signal to be touch data, representing position or touch coordinate, while data processor splits touch data into touch coordinate and key code and sends them to system through the same or two transmission paths.

5. A method or apparatus as recited in claim 2, wherein said main system has one single system.

6. A method or apparatus as recited in claim 2, wherein said main system has two separate systems.

7. A method or apparatus as recited in claim 4, wherein said transmission path is Universal Serial Bus (USB).

8. A method or apparatus as recited in claim 4, wherein said transmission path is Universal Asynchronous Receiver/Transmitter (UART/RS232).

9. A method or apparatus as recited in claim 4, wherein said transmission path include both Universal Serial Bus (USB) and Universal Asynchronous Receiver/Transmitter (UART/RS232).
